(19) United States
(12) Patent Application Publication
(10) Pub. No.: US 2007/0008272 A1
(43) Pub. Date: Jan. 11, 2007

(54) Gate driver circuit for LCD having shared level shifter

(75) Inventors: Ying-Hsin Li, Kaohsiung City (TW); Sheng-Ren Chiu, Puzih City (TW); Jang-Ting Chen, Tainan City (TW)

Correspondence Address: TROXELL LAW OFFICE PLLC, SUITE 1404, 5205 LEESBURG PIKE, FALLS CHURCH, VA, 22041, US

(73) Assignee: ELAN MICROELECTRONICS CORP.

(21) Appl. No.: 11/177,378

(22) Filed: Jul. 11, 2005

(51) Int. Cl. G09G 3/36

(52) U.S. Cl. 345/100

(57) ABSTRACT

The present invention reduces the number of level shifters to obtain smaller layout area while remaining the original function of gate circuit, where a signal from a shift register is transferred to a level shifter for voltage shifting and afterward is transferred to a proper buffer through a selector.

### FIELD OF THE INVENTION

The present invention relates to a gate driver circuit for LCD (Liquid Crystal Display); more particularly, relates to reducing the number of level shifters to obtain smaller layout are a while remaining the original function of the gate driver circuit.

### DESCRIPTION OF THE RELATED ARTS

Please refer to FIG. 6, which is a view showing a basic circuit of a Liquid Crystal Display (LCD) according to a prior art. As shown in the figure, a driver panel IC of an LCD according to a prior art mainly comprises a gate driver circuit [5] and a source driver circuit [6], where the gate driver circuit [5] produces a gate voltage for switching TFT of a pixel on the LCD; and the source driver circuit [6] produces a data voltage for color-scaling the pixel on the LCD. The gate driver circuit [5] comprises a plurality of gate drivers 51 arranged and combined; and the gate driver [51] comprises a shift register (SR) [511], a voltage level shifter (LS) [512] and a buffer [513].

Please further refer to FIG. 7, which is a view showing a flow chart of the gate driver according to the prior art. As shown in the figure, the gate driver circuit [5] for the driver panel IC of the LCD comprises a Vcc signal end [71], a Vss signal end [72], a VGH signal end [73] and a VGL signal end [74]. In a gate driver [51], a signal is transferred from the SR [511 to the LS [512] and afterward is transferred from the LS [512] to the buffer [513]. In a timing of a gate clock for the LCD, only one of the gate drivers [51] obtains output signals of high potential (to switch on LCD) while the others obtain output signals of low potential (to switch off LCD). In another word, only one LS [512] is processed with a voltage shifting at a time while the other LSs [512] are remained with the same voltage.

Please refer to FIG. 8, which is a view showing a circuit of the SR according to the prior art. As shown in the figure, two of the SRs [851, 852] serially connected comprises an input end [81], a first output end [821], a second output end [822], a first clock end [831], a second clock end [832], two Flip Flops [851, 852] and a clock signal [84], where signals from the previous level are locked by the two Flip Flops [851, 852] and are sequentially transferred to the next level. And, the signals of the first clock end [831] and the second clock end [832] are determined by the clock signal [84]; that is to say, the frequency of the clock signal [84] determines the output bandwidth of the SR [851, 852]. Yet, as shown in FIG. 6, SRs [511] are serially connected between gate drivers [51] to transfer high pulse signals in a level by level way and only one high pulse signal appears at a time; therefore, the gate will be opened sequentially. Owing to the characteristic of the liquid crystal, the voltage range for a gate line [52] is between +16 v and −16 v. Yet, because the voltage range for the SR [511] is only between 3 v and 0 v, the voltage range at the output end of each SR [511] is broadened by an LS [512].

Please refer to FIG. 9, which is a view showing a circuit of the LS according to the prior art. As shown in the figure, the LS [9] comprises a first transistor [911], a second transistor [912], a third transistor [913], a fourth transistor [914], a fifth transistor [921], a sixth transistor [922], a seventh transistor [923], an eighth transistor [924], a buffer [93], a signal input [941], a Vss signal end [942], a Vci signal end [943], a signal output [944], a VGH signal end [945] and a VGL signal end [946]. The voltage range of the signals is shifted from a low voltage range (Vci˜Vss) to a high voltage range (VGH˜VGL) by the LS [9]. A first level [91] of the LS [9] comprises the first transistor [911], the second transistor [912], the third transistor [913] and the fourth transistor [914], where signals from the Vci signal end [943] to the Vss signal end [942] are shifted to be transferred from the VGH signal end [945] to the Vss signal end [942]. A second level [92] of the LS [9] comprises the fifth transistor [921], the sixth transistor [922], the seventh transistor [923] and the eighth transistor [924], where signals from the VGH signal end [945] to the Vss signal end [942] are shifted to be transferred from the VGH signal end [945] to the VGL signal end [946]. And, as further referring to FIG. 7, the end-shift buffer [513] is used for impedance matching to receive signals from the LS [512] to be transferred to a gate line [16].

As shown in FIG. 6, according to the prior art, each gate driver [51] comprises an SR [511], a voltage LS [512] and a buffer [513]. So, if there were 220 gate drivers [51], there will be 220 SRs [511], 220 voltage LSs [512] and 220 buffers [513]. Besides, as further referring to FIG. 9, the voltage for VGH can reach 13 v and that for VGL can reach −13 v and Metal-Oxide Semiconductor (MOS) components in the transistors of the third transistor [913] to the eighth transistor [924] are all components for high voltage processes, so that extra NBLs of wells are required. Moreover, for smoothly shifting the voltage of between Vci and Vss, the width for the MOS on the voltage LS [512] must be over 100 um. As a result, in the whole layout, the area occupied by the voltage LS [512] reaches more than one third of the whole gate driver [51]. Hence, a great deal of area on the gate driver circuit [5] is occupied by the voltage LSs [512] deployed. As the resolution of LCD is getting higher while also obtaining more gates, according to the prior art, the layout area of IC will be getting bigger too. So, the prior art does not fulfill users' requests on actual use.

### SUMMARY OF THE INVENTION

Therefore, the main purpose of the present invention is to reduce the number of level shifters to obtain smaller layout area while remaining the original function of gate driver circuit.

To achieve the above purpose, the present invention is a gate driver circuit for LCD having a shared level shifter, where the gate driver circuit comprises a plurality of gate drivers. The gate driver comprises an LS connected to a first selector and a second selector; a plurality of SRs each connected with one of the first selector; and a plurality of buffers each connected with one of the second selector, where a signal from the SR is transferred to the LS for voltage shifting and afterward is transferred to a proper buffer through the second selector. Accordingly, a gate driver circuit for LCD having a shared level shifter is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a view showing a flow chart of a gate driver circuit according to the present invention;

FIG. 2 is a view showing a flow chart of another gate driver according to the present invention;

FIG. 3A and FIG. 3B are views showing circuits of a first selector and a second selector according to the present invention;

FIG. 4A and FIG. 4B are views showing a kind of designs of the first selector and the second selector according to the present invention;

FIG. 5A and FIG. 5B are views showing another kind of designs of the first selector and the second selector according to the present invention;

FIG. 6 is a view showing a basic circuit of a Liquid Crystal Display (LCD) according to a prior art;

FIG. 7 is a view showing a flow chart of a gate driver according to the prior art;

FIG. 8 is a view showing a circuit of a shift register (SR) according to the prior art; and

FIG. 9 is a view showing a circuit of a level shifter (LS) according to the prior art.

### DESCRIPTION OF THE PREFERRED EMBODIMENTS

The following descriptions of the preferred embodiments are provided to understand the features and the structures of the present invention.

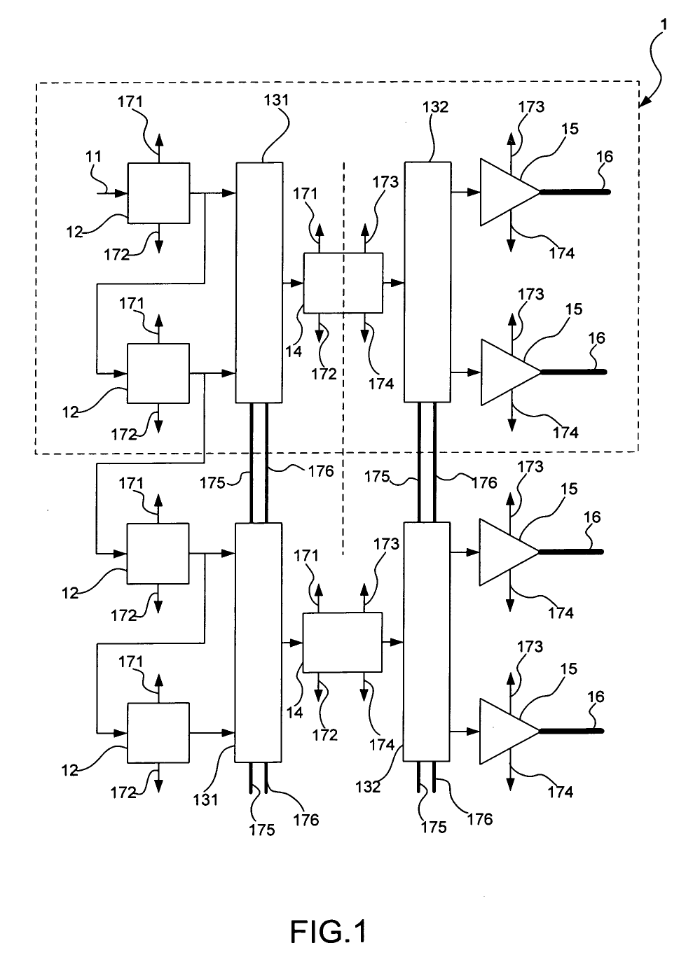

Please refer to FIG. 1 which is a view showing a flow chart of a gate driver circuit according to the present invention. As shown in the figure, a flow chart of a gate driver circuit for LCD having a shared level shifter according to the present invention comprises an initial pulse wave [11], an SR [12], a first selector [131], a second selector [132], an LS [14], a buffer [15], a gate line [16], a Vcc signal end [171], a Vss signal end [172], a VGH signal end [173] and a VGL signal end [174]. The present invention, a gate driver circuit for LCD having a shared level shifter, comprises a plurality of gate drivers [1] each having an LS [14], a plurality of SRs [12] and a plurality of buffers [15], which reduces layout area by reducing the number of LSs [14] while remaining the original function of the gate drivers [1].

Therein, the LS [14] is connected with a first and a second selector [131, 132]; each SR [12] is connected with one of the first selectors [131]; and, each buffer [15] is connected with a second selector [132]. By doing so, a signal from the SR [12] is transferred to the LS [14] for voltage shifting and afterward is transferred to a proper buffer [15] through the second selector [132]. Accordingly, a gate driver circuit for LCD having a shared level shifter is obtained.

Because the LS [14] occupies the largest area in the gate driver [1], the layout area of the gate driver [1] can be reduced by reducing the number of the LSs [14]. For example, when there are 220 gate drivers [1], there will be 220 LSs [14]. But, the present invention makes more than two SRs [12] sharing one LS [14] so that the number of the LSs [14] can be reduced at least to 110, while the first and the second selectors [131, 132] are controlled by a first and a second selection lines [175, 176] to remain the original function of the gate driver [1]. Regarding the area increased by the circuit of the first and the second selectors [131, 132] added, it takes only one tenth of the original area for the LS s [14] so that the total area is greatly reduced.

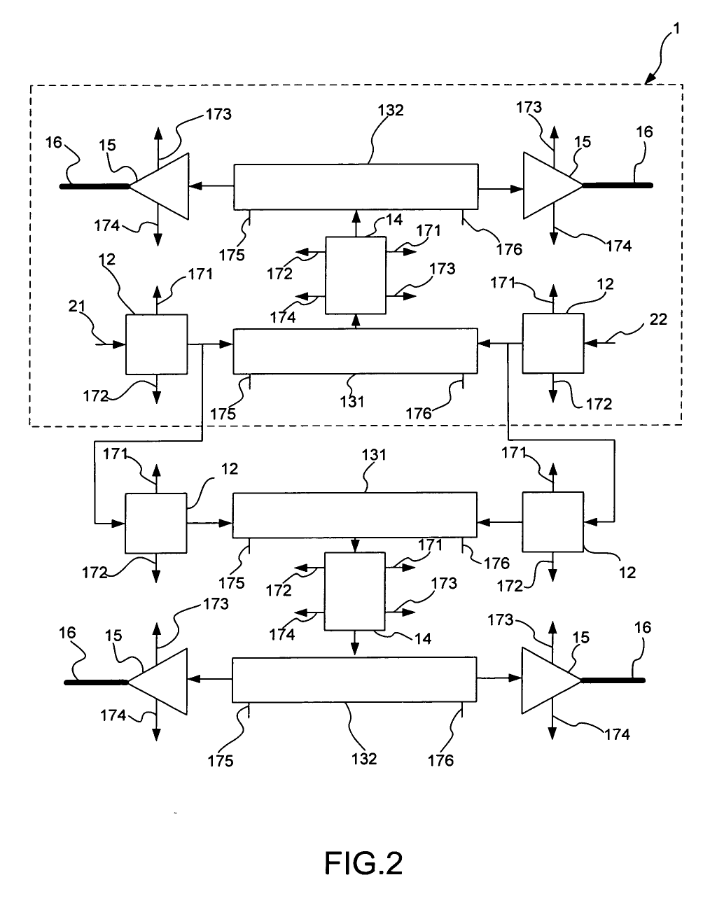

Please refer to FIG. 2, which is a view showing a flow chart of another gate driver according to the present invention. As shown in the figure, a flow chart of another gate driver circuit for LCD having a shared level shifter according to the present invention comprises a first initial pulse-wave [21], a second initial pulse-wave [22], an SR [12], a first selector [131], a second selector [132], an LS [14], a buffer [15], a Vcc signal end [171], a Vss signal end [172], a VGH signal end [173], a VGL signal end [174], a first selection line [175] and a second selection line [176]. The sharing of the LS [14] according to the present invention is not limited to two adjacent gate drivers [1]. The sharing can be for a remote gate driver [1] with a different combination or a different selection signal (select S1, S2, S3, . . . ) for the first and the second selectors [131, 132]. When the signals in the gate drivers [1] are sequential (G1→G2→G3→G4 . . . ) having a regular selection signals, the switching frequency for the selection signals is lower with an LS [14] shared with a farther gate driver [1]; and, the switching frequency is higher with an LS [14] shared with a nearer gate driver [1]. When the signals in gate are non-sequential (G1→G4→G7→G10 . . . →G2→G5→G8→G11 . . . ), an irregular waveform is obtained by the selection signals. In another word, the selection signals change with the combination of the LSs [14] and the transferring status of the gate driver [1].

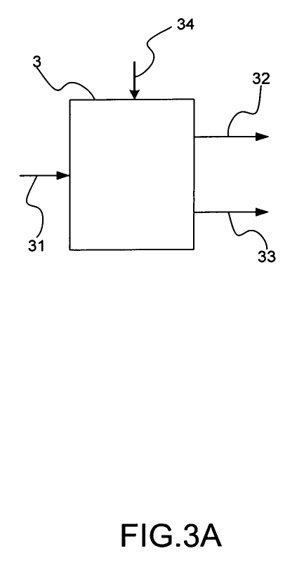

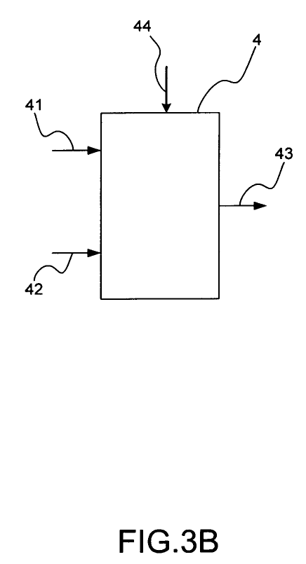

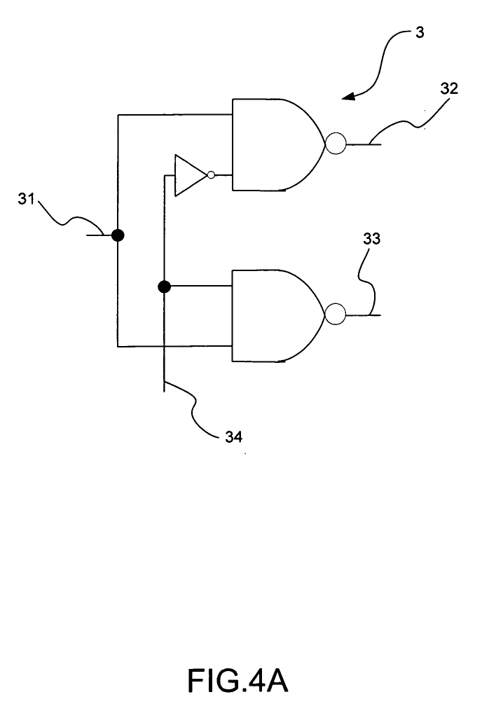

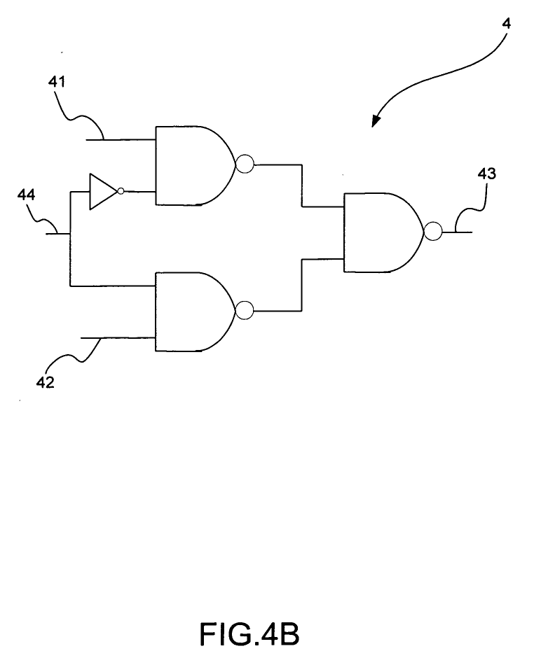

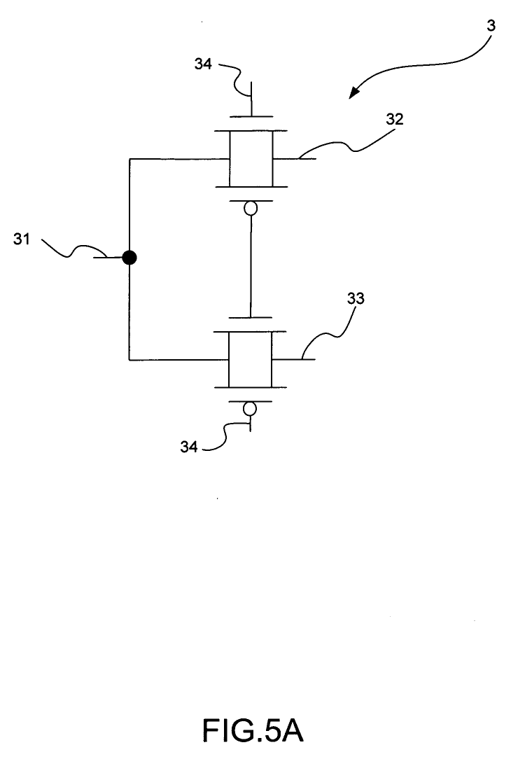

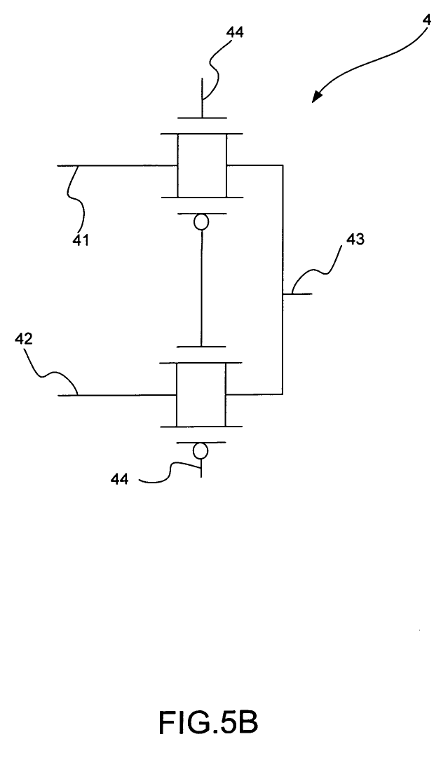

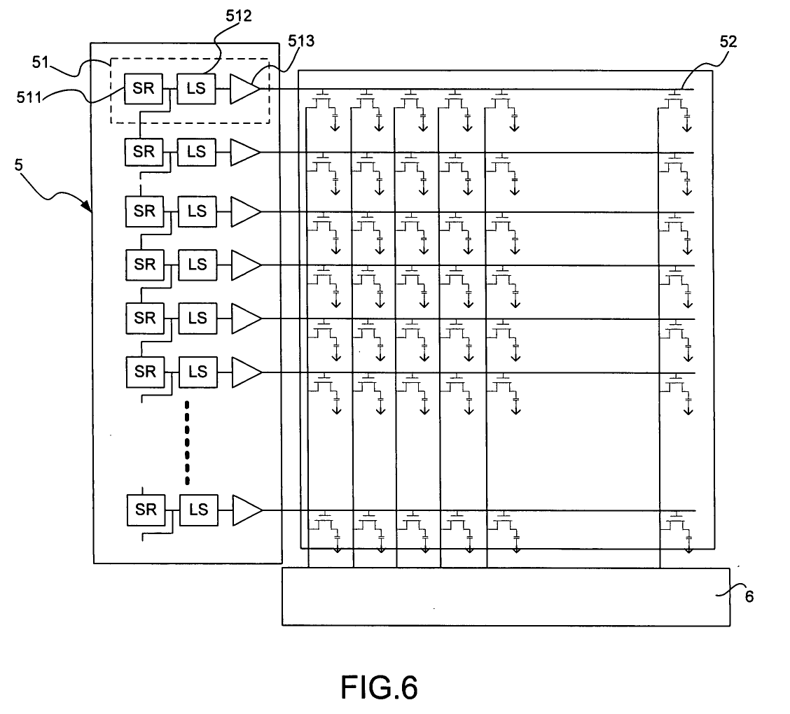

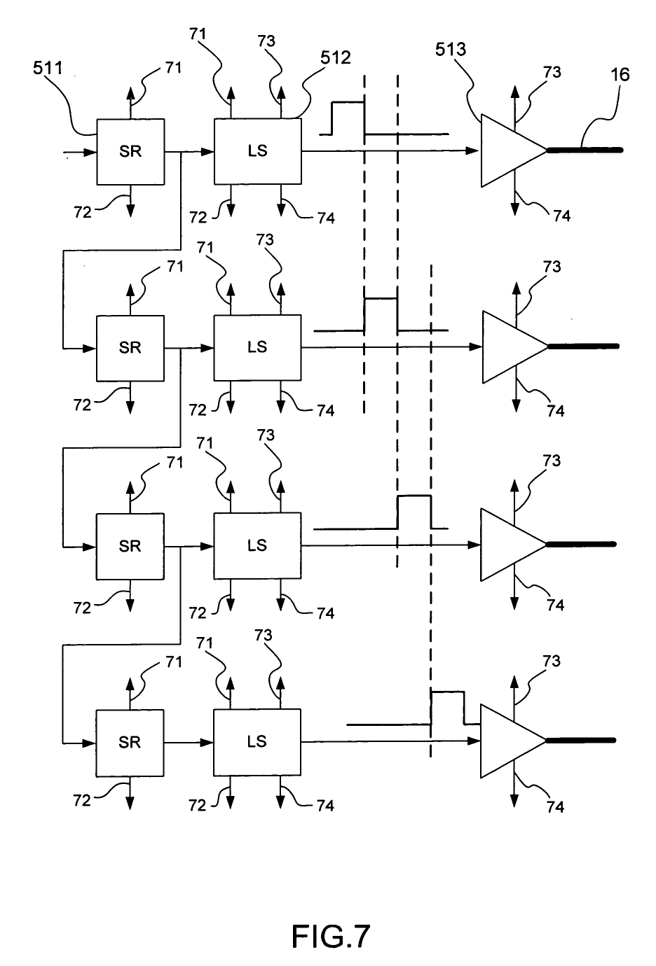

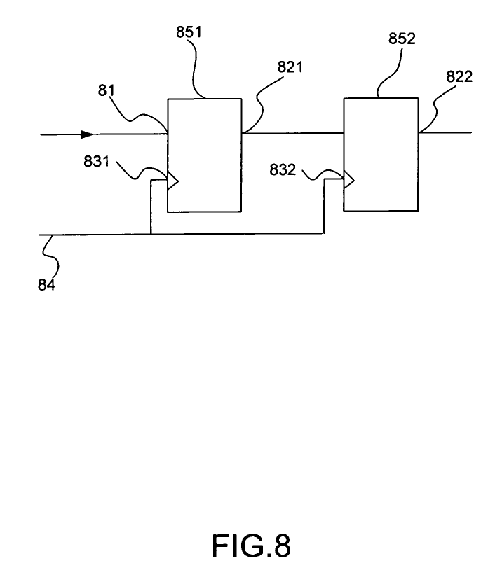

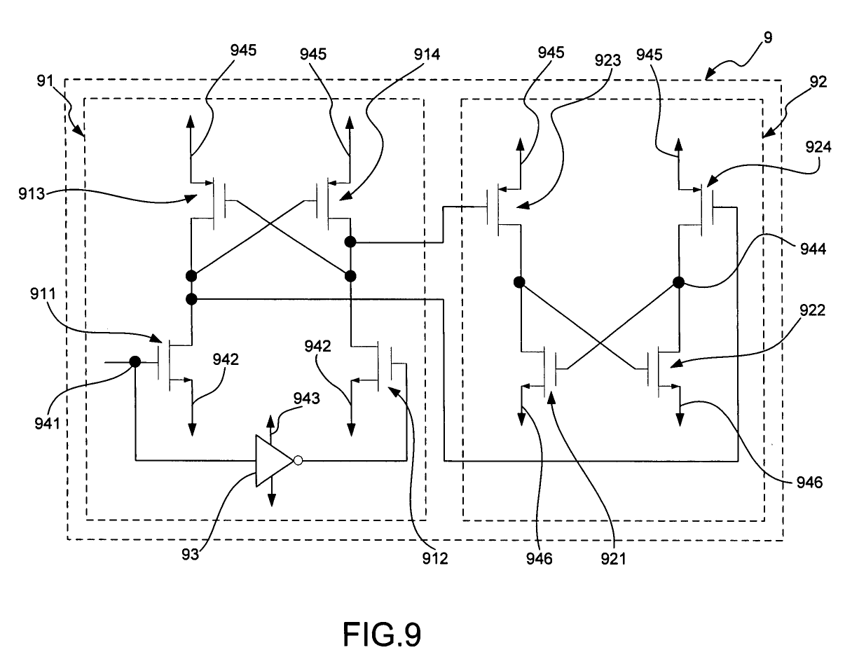

Please further refer to FIG. 3A through FIG. 5B, which are views showing circuits, a kind of designs and another kind of designs of a first and a second selectors according to the present invention. As shown in the figures, the first and the second selectors comprise a Multiplex (Mux) [3], a Mux input end [31], a first Mux output end [32], a second Mux output end [33], a Mux selector end [34], a De-Multiplex (DMux) [4], a DMux input end [41], a first DMux output end [42], a second DMux output end [43] and a DMux selector end [44]. When an LS [14] is shared, a proper gate driver [1] is selected for the input and the output of the LS [14] by using the first selector [131] (the front switch) and the second selector [132] (the end switch). There in, the first and the second selectors [131, 132] can be a Mux [3], as shown in FIG. 3A, having a Mux input end [31], a first Mux output end [32], a second Mux output end [33] and a Mux selector end [34]; or, can be a DMux [4], as shown in FIG. 3B , having a DMux input end [41], a first DMux output end [42], a second DMux output end [43] and a DMux selector end [44]. The Mux [3] and the DMux [4] can be a Complementary Metal-Oxide Semiconductor (CMOS) transmission gate or can be designed as a logic gate so that, by using control signals from selector end [34, 44], a signal from one input end [31] can be transferred to one of the different output ends [32, 33] as shown in FIG. 4A and FIG. 5A; or, a signal can be chosen from one of the different input ends [41, 42] to be transferred to one output end [43], as shown in FIG. 4B and FIG. 5B.

To sum up, the present invention is a gate driver circuit for LCD having a shared level shifter, which, by using a shared LS for every at least two SRs, the number of the LSs can be reduced to obtain smaller layout area while maintaining the original function of the gate circuit.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A gate driver circuit for LCD having a shared level shifter,
said gate driver circuit comprising a plurality of gate drivers,
said gate driver comprising:
(a) a level shifter (LS), said LS connected with a first selector and a second selector;
(b) a plurality of shift registers (SR), said SR connected with said first selector; and
(c) a plurality of buffers, said buffer connected with said second selector,
wherein a signal from said SR is transferred to said LS for voltage shifting and afterward is transferred to said buffer through said second selector.

2. The gate driver circuit according to claim 1, wherein said first selector and said second selector are Multiplexes (Mux).

3. The gate driver circuit according to claim 1, wherein said first selector and second said selector are De-Multiplexes (DMux).

4. The gate driver circuit according to claim 2, wherein said Mux is a Complementary Metal-Oxide Semiconductor (CMOS) transmission gate.

5. The gate driver circuit according to claim 1, wherein said Mux is a logic gate.

6. The gate driver circuit according to claim 3, wherein said DMux is a CMOS transmission gate.

7. The gate driver circuit according to claim 3, wherein said DMux is a logic gate.

8. The gate driver circuit according to claim 1, wherein said LS is connected with two said SRs.

9. The gate driver circuit according to claim 1, wherein said LS is connected with three said SRs.
